(19) United States
(12) Patent Application Publication
(10) Pub. No.: US 2024/0336108 A1
(43) Pub. Date: Oct. 10, 2024

(54) MODULARLY ATTACHABLE CABIN FOR TRACTOR

(71) Applicant: Kubota Corporation, Osaka (JP)

(72) Inventors: Chollawit SURATAD, Nakhon Ratchasima (TH); Nutthawut YINGANANBORWON, Bangkok (TH); Sombut CHAIWONG, Pathumthani (TH); Masataka TAKAGI, Pathumthani (TH)

(21) Appl. No.: 18/749,148

(22) Filed: Jun. 20, 2024

Related U.S. Application Data
(63) Continuation of application No. PCT/IB2022/061798, filed on Dec. 6, 2022.

(30) Foreign Application Priority Data
Dec. 30, 2021 (TH) 2101008276

(51) Int. Cl. B60H 1/00; B60H 1/32

(52) U.S. Cl. CPC B60H 1/00378; B60H 1/3227

(57) ABSTRACT

A modularly attachable cabin for a tractor includes a cabin frame and an upper portion at or adjacent to a supporting structure including a base to connect with the cabin frame, and a slot onto which a heat exchanger is installed. The supporting structure extends laterally from the upper portion of the cabin frame. The heat exchanger is inclined at a predetermined angle relative to the base.

### CROSS REFERENCE TO RELATED APPLICATIONS

This application claims the benefit of priority to Thai Patent Application No. 2101008276 filed on Dec. 30, 2021 and is a Continuation Application of PCT Application No. PCT/IB2022/061798 filed on Dec. 6, 2022. The entire contents of each application are hereby incorporated herein by reference.

### BACKGROUND OF THE INVENTION

### 1. Field of the Invention

This invention relates to modularly attachable cabins tractors.

### 2. Description of the Related Art

Currently, agricultural vehicles or tractors are widely used in agricultural works. Most of them are used as a main vehicle mounted with other components such as a combine or a corn harvester for harvesting, or used in other kinds of work, e.g., for towing agricultural machinery.

Tractors with a cabin generally have components of a cabin structure for a worker to be seated inside configured as a closed room to keep out external dust, sound, or weather. Some types of cabins are further provided with an air conditioning system for controlling temperature and filtering air circulated in the cabin for comfort of the worker operating therein. Therefore, the types of cabins must be installed with a heat exchanger and other devices related to an air condition system.

Most types of tractors have a cabin pre-installed on the main vehicle. Therefore, arrangement of necessary components for the cabin of the tractors with pre-installed cabin can be done easily since each component of the main vehicle can be adapted to satisfy the requirements for installation of the cabin in the original design. However, most workers have in possession main vehicle(s) or tractor(s) without a pre-installed closed cabin and may need to install one later. Accordingly, there is a need for a cabin for installation on a vehicle not originally configured or designed with the consideration on a closed cabin, also referred to as an add-on cabin or a modular cabin, having a main property of being able to be unconditionally installed on or removed from a tractor.

As described above, a cabin with an air-conditioning system requires a heat exchanger which may include a condenser installed on the tractor to transfer heat between a refrigerant and the external environment. How the heat exchanger is installed is a key factor affecting the air-conditioning system's efficiency since its installation position must be designed such that heat or air can be smoothly transferred and the size of the heat exchanger must be suitable for the air-conditioning duty while also able to fit in a limited space on the tractor.

Japanese Patent Document No. JP 5723948 B2 discloses structural positioning of a heat exchanger in an air-conditioning system for a tractor with a pre-installed cabin. It could be seen that a condenser was installed at the front of the vehicle, specifically vertically close to the hood. When installed at this position, the heat exchanger's efficiency could be affected as it was close to other heat generating devices, e.g., radiator and engine. Moreover, the tractor must be originally designed such that a sufficient dedicated space for installation of a heat exchanger must be provided on the front portion of the vehicle. Accordingly, this cannot be done a tractor to be installed with an add-on cabin.

New Zealand Patent Application publication No. NZ 728629 A discloses positioning of a condenser installed on the upper portion of the cabin in horizontal orientation and in the middle of the roof wherein the condenser transferred heat via a side air filter. In addition, a heating unit and a cooling unit are installed close to each other. Such arrangement of the heat exchanger and the filter made access to the filter for cleaning or maintenance difficult and therefore prevention of dust clogging is difficult. Normally, maintenance of a filter disposed next to a condenser in the manner requires replacement of the whole filter set which may need to be done frequently. Therefore, the maintenance of the tractor can be cumbersome and costly.

In addition, in some types of tractors, a heat exchanger is installed vertically on a side of the cabin at the same height as the seat in the cabin. Installation in this manner has a disadvantage as the heat exchanger may, during an operation, block the worker's vision of the vehicle's coupled equipment and its surrounding. Moreover, the heat exchanger is possibly soiled with mud, dirt, or tree branches which may cause damage thereto or reduce its efficiency.

Accordingly, it can be seen that designing an add-on cabin for a tractor and an air-conditioning system for the cabin is a challenge and that it is necessary to design and develop an add-on cabin for a tractor with an air-conditioning system which can be installed thereon and works efficiently.

### SUMMARY OF THE INVENTION

Example embodiments of the present invention provide modularly attachable cabins each including an air-conditioning system which is efficient and easy to clean.

One example embodiment of the present invention provides a modularly attachable cabin for a tractor, the modularly attachable cabin including a cabin frame, a heat exchanger, a supporting structure including a base to connect with the cabin frame, and a slot onto which the heat exchanger is installed, an upper portion at or adjacent to the supporting structure, and a filter frame pivotally attached to the base to hold an air filter, wherein the supporting structure extends laterally from the upper portion of the cabin frame, and the heat exchanger is inclined at a predetermined angle relative to the base.

In an example embodiment, the supporting structure extends laterally from the cabin frame in a rearward direction.

With the structure of the above example embodiment, the cabin is provided with the supporting structure on which a component of an air-conditioning system, specifically the heat exchanger, can be installed and horizontally arranged on the upper portion of the vehicle, specifically the roof of the tractor. The heat exchanger installed in this position does not block the view of the surrounding area so that the worker in the cabin can safely operate the tractor as well as its coupled equipment. In addition, the heat exchanger can be covered with a cover so that it cannot be seen from the outside for aesthetic purposes.

Furthermore, with the supporting structure, the heat exchanger is spaced away from other heat generators, e.g., radiator and engine. Therefore, a temperature difference between the external environment and the refrigerant becomes larger such that heat exchange becomes more efficient.

Additionally, the cabin can be installed on conventional tractors without the need to significantly modify the tractors' components.

In an example embodiment, the predetermined angle between the heat exchanger with respect to the base is at least about 8 degrees, for example.

With the predetermined angle, the heat exchanger can be installed horizontally wherein after heat exchanging, the state (also referred to as “phase”) of most of the refrigerant within the heat exchanger can still be shifted completely. Specifically, most of the refrigerant can be converted from gas to liquid without being retained between both phases such that that refrigerant can be quickly and efficiently transferred from the heat exchanger. Otherwise, if the amount of the refrigerant in liquid phase is significantly high, it will be scattered within the heat exchanger and will be difficult to be transferred from the heat exchanger such that its efficiency will be negatively affected.

Moreover, with the angle combined with the supporting structure's configuration, the heat exchanger can be installed on the tractor without occupying too much space such that other components are not interfered. Accordingly, the cabin can be installed on the tractor.

As noted above, in an example embodiment, the supporting structure further includes a filter frame pivotally attached to the base for holding an air filter.

This structure provides a space to provide an air filter to associate with the heat exchanger. When the air filter is at or adjacent to the heat exchanger in the rear upper portion of the tractor, a user can conveniently access the air filter.

In addition, when the filter frame is pivotally attached to the base, the user can pivotally rotate the filter frame and easily access the air filter for replacement or cleaning.

In a specific example embodiment, fasteners are provided to connect the heat exchanger to the supporting structure. With this structure, the heat exchanger is installed together with the supporting structure which is a part of the cabin such that it can be installed together with the add-on cabin.

Preferably, a fan assembly is installed on the heat exchanger to supply air to the heat exchanger so that heat exchanging is efficiently performed.

In an example embodiment of the present invention, the heat exchanger includes a condenser, which means that when the cabin is being cooled, the heat exchanger will be transferring heat to the external environment such that the refrigerant's phase is changed from gas to liquid in a constant pressure so that the refrigerant is transferred via an expansion valve to an evaporator for cooling the cabin's inside.

In an example embodiment of the present invention, a tractor includes the above-mentioned cabin wherein the cabin can be removed from or installed on the tractor so that it can be converted to one of another type which would increase utility of the cabin according to the present application.

With these example embodiments, all the concepts of the present invention can be practiced without sacrificing advantages known in the art.

The concepts of example embodiments of the invention also encompass a heat exchanger installed on a cabin having the above-mentioned characteristics.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 shows a perspective view of the tractor installed with a modularly attachable cabin according to an example embodiment of the present invention.

FIG. 2 shows a perspective view of the cabin according to an example embodiment of the present invention.

FIG. 3 shows an exploded view of components of the cabin according to an example embodiment of the present invention.

FIG. 4A shows a perspective view of the filter frame in a closed position according to an example embodiment of the present invention.

FIG. 4B shows a perspective view of the filter frame in an open position according to another example embodiment of the present invention.

FIG. 5 shows a cross-sectional view of the portion of the cabin in which the supporting structure according to an example present embodiment of the invention is installed.

### DETAILED DESCRIPTION OF THE EXAMPLE EMBODIMENTS

The above-mentioned subject matter including the description of example embodiments of the present invention to be described in detail below do not limit the scope of the present invention to only the example embodiments disclosed herein. Instead, they are merely exemplifications of example embodiments of the present invention for easy comprehension of concepts of the present invention.

In addition, described characteristics, advantages, and features of the example embodiments may be combined in any suitable manner in one or more example embodiments. A person ordinarily skilled in the art would be able to appreciate from the description of example embodiments of the present application that the present invention can be practiced without certain characteristics or advantages of the example embodiments accompanying specific explanations. In other cases, further characteristics and advantages may be appreciated in certain example embodiments not included in all example embodiments of the present invention.

Next, details of the example embodiments of the invention as illustrated in the accompanying drawings will be referred to. Note that the drawings as well as signs appeared therein are simplified for convenience in description but not limited to the meanings as stated herein. In addition, singular words as used herein are intended to mean “at least one”.

“About” or words having similar meanings used herein when used to describe a quantifiable value or amount, e.g. period of time, temperature, concentration, coefficient, and the like, would include a variation of the value or amount in the range of ±20%, ±10%, ±5%, ±1%, and ±0.1% from the directly specified value as appropriate, for example.

In the present application, example embodiments according to the present invention may be presented as ranges. Therefore, it is to be understood that the descriptions as ranges are for convenience and conciseness but not intended to be and not to be construed as a limitation of scope of the present invention according to the present application. Therefore, the descriptions as ranges should also be construed to include all subranges and single values in the ranges. For example, a range of number of from 1 to 6 should be considered to also include subranges e.g. from 1 to 3, from 1 to 4, from 1 to 5, from 2 to 4, from 2 to 6, from 3 to 6, etc. and all single values, e.g., 1, 2, 2.7, 3, 4, 5, 5.3, 6, etc. This applies no matter how large the specified ranges are.

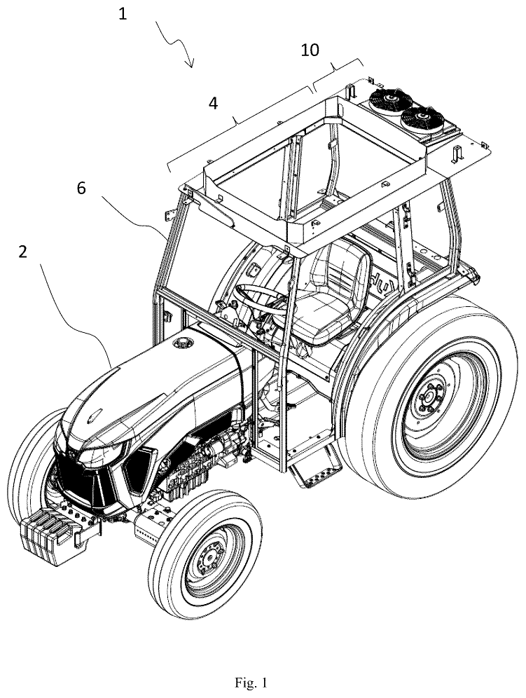

The example embodiments of the present invention will be described in detail with reference to FIGS. 1 to 5 as follows.

FIG. 1 shows the tractor 2 installed with the modularly attachable cabin or the add-on cabin or other similar cabins hereinafter referred to as the cabin 1.

One of the remarkable properties of the cabin 1 according to an example embodiment of the present invention is its ability to be installed on common tractor 2, particularly the tractor 2 without a pre-installed cabin and/or a pre-installed air conditioning system. The term “pre-installed cabin” includes a cabin configured as an enclosure to the user of the tractor for work.

The cabin 1 mainly includes the cabin frame 6 defining and functioning as the main structure and connected to the tractor 2. The cabin frame 6 normally includes an assembly which may be altered according to applications by those ordinarily skilled in the art to be compatible with and to be installed on the tractor 2.

The cabin 1 further includes the upper portion 4 of the cabin frame 6 positioned on the upper portion wherein the tractor 2 may further include the cover (not shown in the drawings) on the upper portion 4 to define a roof assembly. In this regard, the upper portion 4 is positioned close to the supporting structure 10. Particularly, the upper portion 4 is directly connected to the supporting structure 10 via welding and the supporting structure 10 extends from the upper portion 4, preferably in the rearward direction of the cabin 1.

The extension in a rearward direction of the supporting structure 10 enables a convenient access by the user to components associated to the supporting structure 10 including the heat exchanger and the filter as described in detail below.

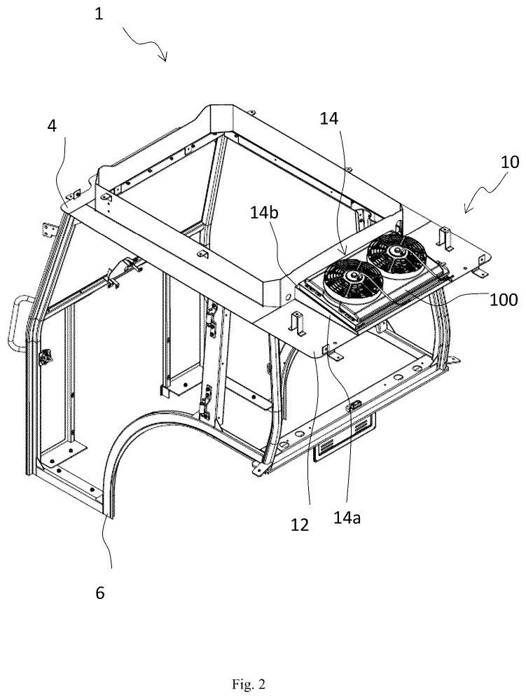

FIG. 2 shows the cabin 1 with the supporting structure 10 connected to the upper portion 4 which can support the heat exchanger 100 wherein the supporting structure 10 mainly includes the base 12 and the slot 14.

The base 12 of the supporting structure 10 is connected to the upper portion 4. Preferably, the base 12 is parallel or substantially parallel to the ground level.

The slot 14 is positioned on the upper side and is connected to the base 12 and defines and functions as the main structure for connection to and holding the heat exchanger 100. The slot 14 includes a connecting ridge 14a positioned vertically and perpendicular or substantially perpendicular to the base 12 and a main surface 14b disposed horizontally with a predetermined inclination.

The cover (not shown in the drawings) can also be fit on the supporting structure 10 as a part of the roof assembly.

In addition, the supporting structure 10 can also support additional components, e.g., the tractor's taillights.

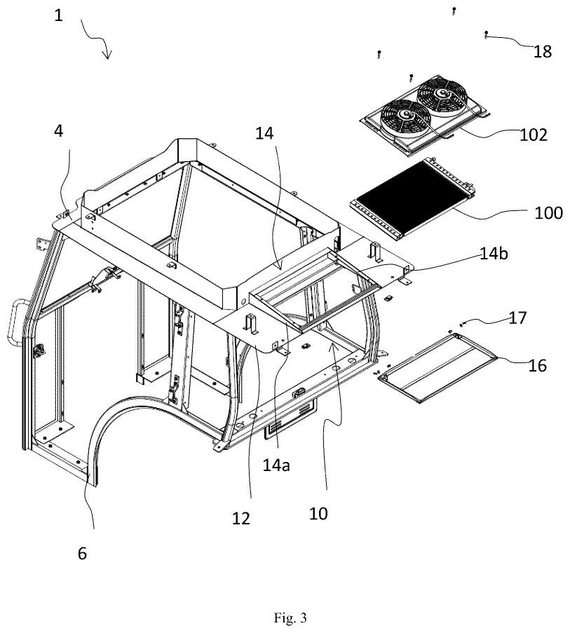

FIG. 3 shows the connection between the heat exchanger 100 and the supporting structure 10. Specifically, the main surface 14b of the supporting structure 10 directly holds the heat exchanger 100. Therefore, the main surface 14b is one of the main components defining a predetermined inclination or angle of the heat exchanger 100 with respect to the base 12.

Moreover, FIG. 3 shows the fan assembly 102 installed on top of the heat exchanger 100 to feed air into the heat exchanger 100 for use in heat exchange or transfer between the refrigerant and the external environment wherein the fan assembly 102 has an inclined plane corresponding to the heat exchanger 100.

In an example embodiment, the fasteners 18 are provided as screws to connect the heat exchanger 100 to the supporting structure 10 wherein holes are provided on the main surface 14b of the supporting structure 10 to hold the fasteners 18 so that the fasteners 18 can be fastened between the heat exchanger 100 and the supporting structure 10. Specifically, holes are also provided on the fan assembly 102 to hold the fasteners 18 and the fasteners are fastened through the main surface 14b, the heat exchanger 100, and the fan assembly 102.

In addition, FIG. 3 further shows the filter frame 16 pivotally attached to the base 12 to support the air filter (not shown in the drawings) also called as an air filter sheet or air filter screen for use with the heat exchanger 100. Preferably, the filter frame 16 and the filter are installed under the heat exchanger 100 using a pin set 17 fastened between a protrusion of the base 12 and the support of the filter frame 16 such that the filter frame 16 is pivotable about the pin set 17.

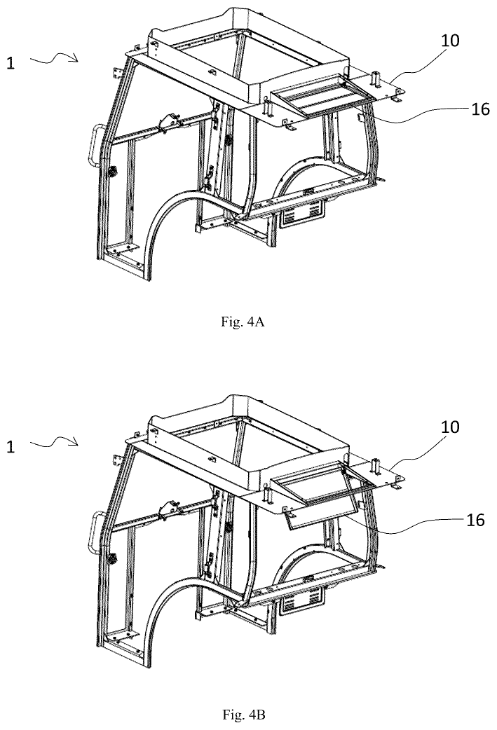

FIGS. 4A and 4B show two disposition of the filter frame 16 for comparison.

FIG. 4A shows the filter frame 16 in a closed position which is an arrangement where the filter sheet or the filter is coupled to the heat exchanger (not shown herein) to filter air circulated by a fan during the air conditioning system's operation. The filter frame 16 generally has a tray-shaped configuration to hold the filter sheet which is coupled to the heat exchanger. This is the normal position for use in an air-conditioning system.

FIG. 4B shows the filter frame 16 in an open position in which it is downwardly inclined and defines a space for access to the filter. In addition, in combination with the property of the rearward protrusion of the supporting structure 10 from the cabin 1, the arrangement and position will result in the space for access to the filter being in the rear of the vehicle close to the roof where the user can easily access. When the user needs to replace or clean the filter, he or she can simply go to the rear of the vehicle and open the filter frame 16 so that it remains in the open position and the filter can be directly accessed to. Also, the filter can be conveniently cleaned or replaced without using additional tools and maintenance time is reduced. Therefore, its efficiency is increased.

The switch of the positions of the filter frame 16 from the closed position to the open position or vice versa is possible since the filter frame 16 is pivotable as explained above using tools, e.g., hinges or the like.

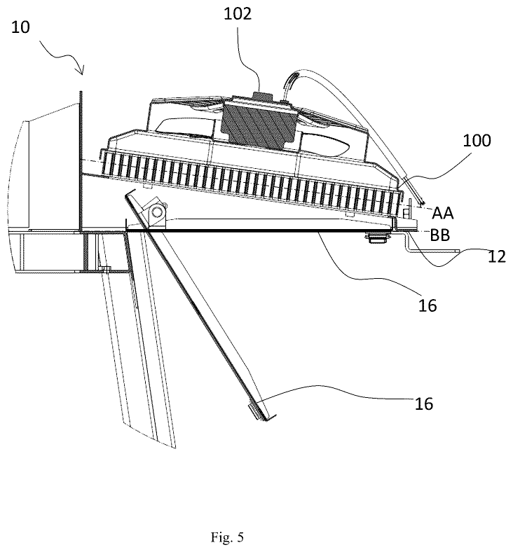

FIG. 5 shows a cross-sectional view of the supporting structure 10 which clearly illustrates the arrangement of the heat exchanger 100 as compared with the base 12.

In an example embodiment of the present invention, the heat exchanger 100 is inclined in a predetermined angle with respect to the base 12. The predetermined angle is at least about 8 degree to facilitate the flow of the refrigerant inside the heat exchanger 100 caused by the gravity while still allowing the latter to be attachable to another part. If the predetermined angle is larger, preferably, the flow of the refrigerant will be better facilitated. However, the increased angle will increase the heights of components including the heat exchanger 100 and the fan assembly 102 and may affect its compatibility with other components of the roof, e.g., the cover.

In an example embodiment, the heat exchanger 100 is inclined such that its height is reduced in the front-to-rear direction in a lateral side view. The refrigerant is supplied into the heat exchanger 100 at the higher end of the heat exchanger 100 and discharged at the lower end thereof.

Preferably, the predetermined angle is about 8 degrees, for example.

Specifically, the predetermined angle is obtained by intersecting the plane of the heat exchanger 100 with that of the base 12 as represented by the line AA and BB respectively in FIG. 5 wherein the angle between the two lines is taken as the predetermined angle or preferably about 8 degrees, for example.

In addition, FIG. 5 shows the arrangement of the filter frame 16 in the closed position and the open position. In the closed position, the filter frame 16 is parallel or substantially parallel to the base 12 and in the open position, the filter frame 16 is inclined with respect to the base 12.

In combination with FIG. 3, the inclination of the heat exchanger 100 is caused by its disposition on the main surface 14b of the slot 14. Therefore, the main surface 14b also defines an angle corresponding to that of the heat exchanger 100.

In an example embodiment, the heat exchanger 100 includes a condenser, also called as a hot coil, wherein the refrigerant flows in a direction corresponding to the inclination angle of the heat exchanger 100. In other words, the refrigerant in a gas phase enters the heat exchanger 100 in a higher portion and flows along an internal path to transfer heat to the external environment, thus changing the phase of the refrigerant from gas to gas-liquid mixture and to liquid. During the phase change, the refrigerant flows along the path due to gravity since the heat exchanger 100 is inclined to facilitate the flow of the refrigerant to an outlet at a position lower than the inlet so that the refrigerant is transferred for pressure reduction thereafter. Also, the inclination angle reduces the chance that the refrigerant is clogged inside the heat exchanger 100 due to incomplete phase change.

In an alternative example embodiment, the heat exchanger 100 can be replaced with an evaporator so that the air conditioning system's operation become similar to that of a heat pump.

Furthermore, an example embodiment of the present invention may also include the cabin 1 with multiple heat exchangers 100 of the same type as long as at least one of the heat exchangers 100 is installed in the same manner as that described in one of the example embodiments of the cabin 1 as explained above.

With regard to other related components of the air conditioning system, the heat exchanger for the cabin is disposed on the upper middle position of the cabin, a refrigerant tube is disposed along the cabin frame, and a compressor can be disposed on the front hood of the tractor. However, disposition of these components can be modified by a person ordinarily skilled in the art of air conditioning systems.

In an additional example embodiment, the tractor 2 includes the modularly removable or attachable cabin 1 including the supporting structure 10 as explained above. In another example embodiment, the air conditioning system includes the heat exchanger 100 installed on the supporting structure 10 wherein the air conditioning system is installed on the cabin 1 which can be associated with the tractor 2.

As mentioned above, it can be seen that the explained modularly attachable or add-on cabin 1 achieves the above noted advantages and includes an efficient air conditioning system and can be conveniently cleaned.

While example embodiments of the present invention have been described above, it is to thebe understood that variations and modifications will be apparent to those skilled in the art without departing from the scope and spirit of the present invention. The scope of the present invention, therefore, is to be determined solely by the following claims.

What is claimed is:

1. A modularly attachable cabin for a tractor, the modularly attachable cabin comprising:
a cabin frame;
a heat exchanger;
a supporting structure including a base to connect with the cabin frame, and a slot onto which the heat exchanger is installed;
an upper portion at or adjacent to the supporting structure; and
a filter frame pivotally attached to the base to hold an air filter; wherein
the supporting structure extends laterally from the upper portion of the cabin frame; and
the heat exchanger is inclined at a predetermined angle relative to the base.

2. The cabin according to claim 1, wherein the supporting structure extends laterally from the cabin frame in a rearward direction.

3. The cabin according to claim 1, wherein the predetermined angle is at least about 8 degrees.

4. The cabin according to claim 1, wherein a fan assembly is provided on the heat exchanger to supply air to the heat exchanger.

5. The cabin according to claim 1, further comprising fasteners to connect the heat exchanger to the supporting structure.

6. The cabin according to claim 1, wherein the heat exchanger includes a condenser.

7. A tractor comprising the cabin according to claim 1.

8. An air conditioning system of the cabin according to claim 1, wherein the heat exchanger is installed on the supporting structure.
